(19) United States
(12) Patent Application Publication
(10) Pub. No.: US 2005/0212396 A1
(43) Pub. Date: Sep. 29, 2005

(54) Par lamp with negative draft neck and method of assembling the lamp

(75) Inventors: James E. Oetken, Winchester, KY (US); Michael R. Kling, Lexington, KY (US); George Kendrick, Lexington, KY (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/157,680

(22) Filed: Jun. 21, 2005

(51) Int. Cl. H01J 5/48; H01J 5/16; H01J 61/40

(52) U.S. Cl. 313/318.11; 313/113

(57) ABSTRACT

A tungsten-halogen or HID parabolic reflector lamp construction and assembly method is described that improves lamp performance by increasing the area of the parabolic reflective surface while reducing manufacturing cost by simplifying assembly. The reflector has a small opening just large enough to accommodate the light source capsule and a reverse draft angle in the neck. The capsule is attached directly or indirectly to a standard medium screw threaded base minimizing the number of separate lamp components and assembly operations.

### BACKGROUND OF THE INVENTION

### Field of the Invention

The invention relates to electric lamps and particularly to electric lamps with reflectors. More particularly the invention is concerned with an electric PAR lamp with a lamp capsule light source.

### DESCRIPTION OF THE RELATED ART INCLUDING INFORMATION DISCLOSED UNDER 37 CFR 1.97 AND 1.98

PAR lamps commonly comprise a light source such as a tungsten halogen capsule or arc tube mounted in a pressed borosilicate glass reflector having a reflective coating formed on the inner parabolic surface. A pressed glass lens with optical elements to shape the beam usually covers the front. PAR lamps usually have the form of a parabolic bowl forming the reflector and a neck extending between the parabolic reflector section and a medium screw lamp base used for electrical connection. The base is typically designed to receive normal line power (100 V to 240 V). The neck provides room for the capsule's press seal, leads, capsule mounting components, electrical wiring, and also separates the filament from the threaded base to reduce the base temperature. Small holes in the base of the neck penetrate the reflector to enable electrical connection to the capsule. Most PAR lamps are assembled by inserting the capsule from the front aperture and attaching the capsule leads through the reflector heel by means of eyelets, ferrules, ceramic body, cement, or metal clip. A metal clip is also sometimes also used in the neck region to align and support the capsule. FIG. 1 shows a cross sectional view of such a prior art PAR lamp.

Both the inner and outer surfaces of the prior art reflector need a suitable draft angle for removal from the mold. Pressed glass used for PAR lamps typically requires a minimum draft angle of about 3 degrees and in practice, a 5 degree draft angle is used. The bottom of the reflector neck must have an adequate diameter to fit the capsule's press seal and the capsule mounting elements. The opening at the parabolic reflecting surface is therefore significantly larger than the capsule diameter. This wide opening allows light to enter the neck region that is then lost due to multiple reflections and absorption by mount and capsule components. This lost light does not contribute to the output beam, and only heats the base.

A way to reduce neck opening diameter is described in U.S. Pat. No. 5,281,889. A substantial portion of the open reflector neck volume is replaced by a separate ceramic extender and the capsule is mounted with a metal disk between the ceramic extender and the reflector. A disadvantage of this approach is the relatively high part count and the complicated assembly requiring the use of cement to attach the various components. The ceramic extender adds significantly to the total lamp cost.

### BRIEF SUMMARY OF THE INVENTION

A reflector lamp assembly may be formed from a reflector having the form of a shell with an interior surface and an exterior surface, the interior surface defining a reflective surface. The reflector is formed with an internal wall defining a passage extending through the reflector from the interior surface to the exterior surface. A lamp capsule encloses a light source with a first electrical lead and a second electrical lead, the capsule having an exterior wall, the lamp capsule being shaped and sized to extend through the passage. The light source exterior wall is closely positioned by the internal wall of the reflector adjacent the reflective surface to accurately locate the light source relative to reflective surface and expose the reflective surface to light emitted by the light source. A threaded base having a first electrical contact coupled to the first lead and a second electrical contact coupled to the second lead, mechanically supports the capsule. The threaded base is mechanically then coupled to the exterior of the reflector.

### BRIEF DESCRIPTION OF THE SEVERAL VIEWS OF THE DRAWINGS

FIG. 1 shows a cross sectional view of a prior art PAR lamp.

FIG. 2 shows a cross sectional view of a preferred PAR lamp.

FIG. 3 shows a cross sectional view of a preferred PAR lamp reflector.

### DETAILED DESCRIPTION OF THE INVENTION

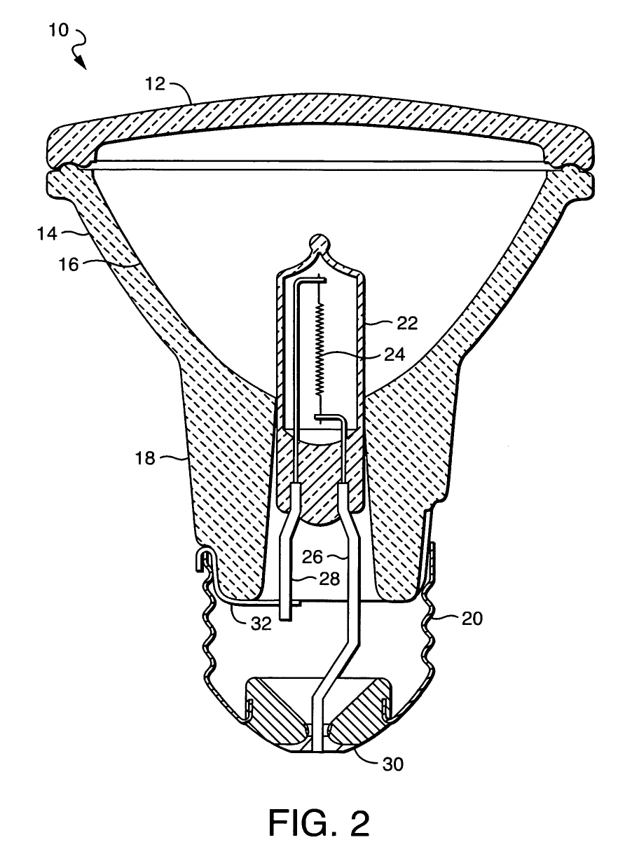

FIG. 2 shows a cross sectional view of a preferred embodiment of the parabolic reflector lamp 10 using the new reflector and capsule mount. The lamp 10 includes a cover glass lens 12 glued to a glass reflector 14 with reflective layer 16 formed on the interior parabolic surface. The reflector 14 extends by a neck region 18 that is attached to medium screw threaded base 20 by peening. In the preferred construction, a tungsten halogen capsule 22 containing a filament light source 24 is fixed in the reflector 14. The preferred tungsten halogen capsule 22, is made from a hard glass tube, and an enclosed filament light source along with a halogen fill, as is known in the art. The typical hardglass lamp capsule includes molybdenum seal foils, and is known to be relatively tolerant of high temperatures, such as those that might be seen in an enclosed lamp neck. The filament light source 24 is preferably located to overlap the focal point of the reflector 14, for example by locating the center of the filament light source 24 at the focal point. This is to optimize the lamp for maximum center beam candlepower. The filament light source 24 is electrically coupled to a first lead 26, and to a second lead 28 that extend through the neck cavity to the threaded base 20. The first lead 26 may be soldered to a center eyelet 30 in the threaded base 20. The second lead 28 may be coupled to a small diameter fuse wire 32 that is in turn welded to the upper region of the threaded base 20.

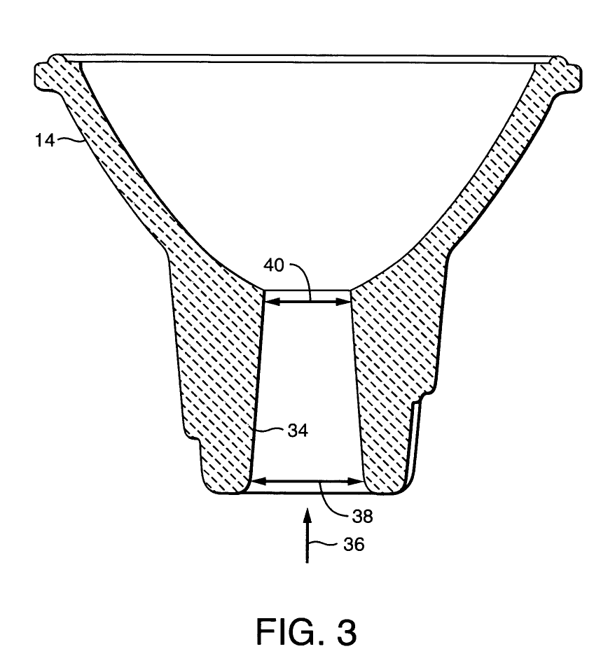

FIG. 3 shows a cross sectional view of a preferred PAR lamp reflector. The reflector 14 has the general form of a shell with an interior surface and an exterior surface. Defined on the interior surface is a reflective surface. The reflector 14 is formed with an internal wall 34 defining a passage extending through the reflector 14 from the interior surface to the exterior surface. The reflector 14 has an internal wall 34 defining a through passage 36 extending from the exterior surface at a base end 38 through the reflector 14 to the interior surface at an inner end 40 adjacent the reflective surface region. The through passage 36 has a relatively wider base end 38 and a relatively narrower inner end 40. The neck then has a negative draft angle. Preferably the inner end 40 has a cross section that is only slightly larger than the outer diameter of the lamp capsule 22. The inner end 40 then closely cradles the lamp capsule 22 in a preferred position. Ideally the whole filament light source 24 is located axially forward of the narrow inner end 40. Little or no light is then lost in the crevice of the through passage 36 between the reflector 14 and the lamp capsule 22, and relatively more of the light emitted sideways from the filament light source 24 falls on the forward reflecting portions of the reflector 14. In combination the close relation between the filament light source 24 and reflector 14 improves the percentage of emitted light that is reflected forward in the desired beam pattern. The preferred reflector 14 is made of pressed glass, but could be made from a ceramic or similar material tolerant of the lamp heat, and able to support a reflective surface.

The preferred lamp construction eliminates the need for eyelets and a separate wire connecting the first capsule lead to threaded base center eyelet 30. A fuse wire 30 is welded to the trimmed capsule lead 28. Lamp lead 26 is attached directly to the medium screw threaded base 20 by welding or soldering the long capsule lead 26 to the center eyelet 30. The lamp capsule 22 and threaded base 20 assembly may be coupled as a unit in advance and then attached to the reflector 14 by peening the top skirt of the brass threaded base 20 into fixed coupling with the reflector 14. An adhesive may also couple the reflector 14 and threaded base 20. The lens 12 may then be attached to the reflector 14 by glue.

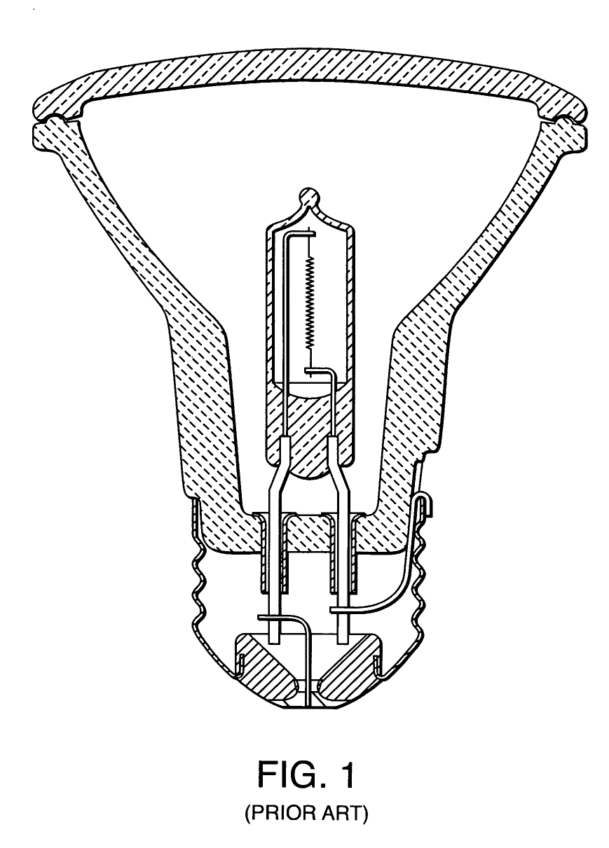

The PAR lamp with negative draft neck provides the performance advantages associated with small reflector opening along with cost advantages of the simplified assembly process. The Applicants measured a ten percent (10%) increase in center beam candlepower for a PAR20 lamp with the lamp construction as shown in FIG. 2 as compared to a standard PAR20 reflector lamp with the construction shown in FIG. 1. Total lumens and beam pattern are also improved with the new lamp. The lamp-to-lamp performance variation was also greatly reduced. The new lamp structure is applicable to any size PAR lamp but is believed to provide the greatest performance gains in smaller size lamps. The manufacturing advantages apply to all PAR lamps having a neck region with draft angle opening toward the lens aperture.

In general, the standard pressed glass reflector used in a PAR lamp may be replaced with a reflector having similar external shape but with an opening in the parabolic reflecting surface only slightly larger than the light source capsule diameter. The draft angle of the reflector neck passage is reversed so that the neck diameter is greatest at the bottom near the threaded base, and least near the reflector region. In the preferred embodiment the internal diameter of the neck is narrowest adjacent the reflective surface, and is slightly larger than the outside diameter of the lamp capsule. The narrow fit between the two parts centers the capsule on the lamp axis, and therefore properly locates the enclosed filament. The lamp capsule is positioned along the axis by setting the first electric lead length, the one extending from the center eyelet contact. Alternatively the lamp capsule could be positioned along the lamp axis by abutting contacts formed on the lamp capsule and the reflector. The lamp may use a conventional medium screw threaded base that is attached without cement. The threaded base can be securely attached to the reflector by being deformed into slots or depressions or around protuberances on the nose of the reflector near the threaded base seat. The reflector may be made from glass, ceramic, or high temperature plastic. Molding the reflector may leave a thin web of material adjacent the parabolic surface and crossing the neck opening. A hole can be subsequently formed between upper reflector cavity and lower neck cavity by punching, drilling, or burning through this thin residual web.

The new reflector shape enables a new manufacturing process. The lamp capsule is inserted from the bottom of the reflector and need not be attached directly to the reflector with eyelets or a clip. Instead, a rigid first capsule lead can be bent and attached directly to the center eyelet of the threaded base by welding or soldering. A simple fuse wire can be used to make electrical contact between a second lead and the threaded base shell. The second capsule lead may alternately be bent outward and attached directly to the threaded base shell by welding or soldering to the inside surface and a fuse wire connected to the center eyelet. To avoid the need to bend capsule lead wires, a wire or clip may be used as an intermediate component between the capsule lead and threaded base shell or center eyelet. This new lamp assembly eliminates two metal eyelets and possibly the side wire needed to connect a capsule lead to the threaded base, reducing the total part count by at least twenty-five percent.

The capsule mount needs adequate strength to maintain proper capsule centering in the reflector. In the new structure, the small opening of the neck adjacent the reflector braces the lamp capsule and prevents the capsule from moving off axis. At the same time, the stiff capsule lead or leads prevent axial movement of the capsule. This accurate capsule positioning substantially reduces the variation in center beam candlepower and beam shape that occurs with typical PAR lamps.

The new design eliminates two assembly process steps (eyelet staking and capsule insertion) that historically have limited production line speed and reduced line efficiency. Instead, the capsule may be attached directly to the lamp's threaded base in one of the final process steps. The capsule is the most expensive lamp component and the new process substantially reduces the cost of scraping defect parts discovered just before the final assembly.

With a clear glass reflector, it may be desirable to coat the inner or outer surface of the neck with an opaque coating to prevent light escaping out the reflector back. Opaque ceramic or plastic can also prevent or minimize this effect.

While there have been shown and described what are at present considered to be the preferred embodiments of the invention, it may be apparent to those skilled in the art that various changes and modifications can be made herein without departing from the scope of the invention defined by the appended claims.

1. A reflector lamp assembly comprising:
a reflector having the form a of a shell with an interior surface and an exterior surface, the interior surface defining a reflective surface, the reflector being formed with an internal wall defining a passage extending through the reflector from the interior surface to the exterior surface;
a lamp capsule enclosing a light source with a first electrical lead and a second electrical lead, the capsule having an exterior wall, the lamp capsule shaped and sized to extend through the passage, the light source exterior wall being closely positioned by the internal wall of the reflector adjacent the reflective surface to accurately locate the light source relative to reflective surface and expose the reflective surface to light emitted by the light source; and
a threaded base having a first electrical contact coupled to the first lead and a second electrical contact coupled to the second lead, the threaded base mechanically supporting the capsule, and the threaded base being mechanically coupled to the exterior of the reflector.

2. The lamp in claim 1, wherein the reflector is formed from a ceramic material.

3. The lamp in claim 1, further including a lens coupled to the reflector to enclose the capsule.

4. The lamp in claim 1, wherein the reflective surface has a defined focal point, and the light source is positioned close to or overlapping the focal point.

5. A method constructing a PAR lamp, comprising the steps of:
forming a reflective reflector having a defined reflective surface, and an internal wall defining a narrow through passage extending from the exterior of the reflector to the reflective surface;
forming a threaded base mechanically supporting, and providing electrical connection for a lamp capsule, the lamp capsule having an exterior wall closely sized to conform to the internal wall;
mechanically mounting the lamp capsule to the base and electrically coupling the lamp capsule to the base;
accurately extending the lamp capsule axially through the passage with the capsule positioned by the through passage and the light source exposed the reflective surface; and
fixing the threaded base to the exterior of the reflector.
